(19) United States
(12) Patent Application Publication
(10) Pub. No.: US 2005/0180176 A1
(43) Pub. Date: Aug. 18, 2005

(54) Welding set with quasi-resonant soft-switching inverter

(76) Inventor: Peyofougou Coulibaly, Saint-Ouen l'Aumone (FR)

Correspondence Address: Linda K. Russell;Suite 1800, 2700 Post Oak Blvd., Houston, TX, 77056, US

(21) Appl. No.: 11/053,424

(22) Filed: Feb. 7, 2005

(30) Foreign Application Priority Data
Feb. 12, 2004 (FR) 0450250

(51) Int. Cl. H02M 3/335

(52) U.S. Cl. 363/17

(57) ABSTRACT

An apparatus for arc welding using a quasi-resonant, soft-switching type inverter. The inverter is connected to an electrical energy power source at a point between a power supply terminal and a reference terminal. The inverter has at least one quasi-resonant type switching leg. The leg is made of an even number of switches, arranged in series, and an output terminal located between the two central switches. The inverter is connected to a circuit for controlling the switches and also has a transformer. The primary element of the transformer is linked to the output terminals of the switching legs, while the secondary element of the transformer is linked to a rectifier which supplies a DC output voltage. The inverter also has a intermediate power supply terminal located between the power supply and the reference terminal. The output terminal of each switching leg is linked to the intermediate power supply terminal by an inductive element.

The present invention relates to an electric arc welding set comprising a “quasi-resonant soft-switching” type inverter.

In the “power electronics” domain, there are now inverters that can deliver DC output voltages which operate on a “soft-switching” principle.

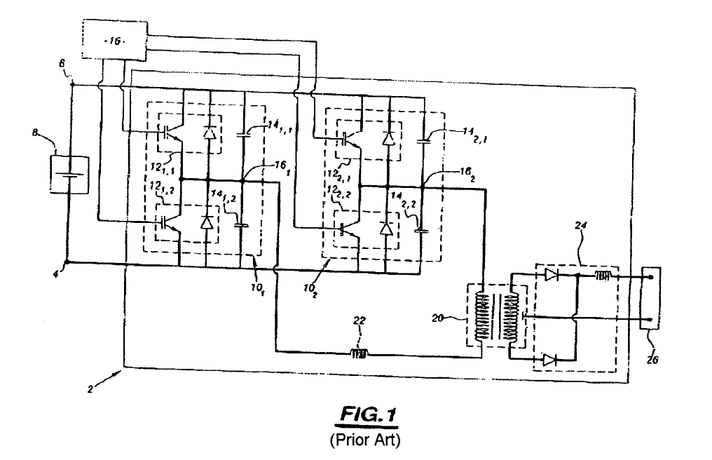

The electrical circuit diagram of such a known quasi-resonant soft-switching inverter is represented for reference in FIG. 1 in a functional configuration.

This inverter 2 is connected between a reference terminal 4 and a power supply terminal 6 of a DC voltage source 8.

Switching cells or legs denoted in general by the reference number 10 and in particular by the references 10₁ and 10₂, are arranged in parallel between the terminals 4 and 6 of the voltage source 8. These legs 10 each comprise two switches linked in series between the terminals 4 and 6. The switches are denoted in general by the numeric reference 12 and in particular by the references 12_{1,1}, 12_{1,2}, 12_{2,1} and 12_{2,2}.

Each switch 12 conventionally comprises one or more controllable thyristors or transistors, at the terminals of which diodes are mounted in anti-parallel fashion.

Furthermore, each switch 12 of each switching leg 10, is also mounted in parallel with a switching-assisting capacitive element, denoted in general by the numeric reference 14 and in particular by the numeric references 14_{1,1}, 14_{1,2}, 14_{2,1} and 14_{2,2}.

The switching legs 10₁ and 10₂ thus each present an output terminal 16₁ and 16₂ taken between the two central switches of each leg.

Moreover, each switch 12 of each leg 10 is linked for its control to a control device 16 external to the inverter 2.

The inverter 2 also comprises a transformer 20, the primary of which is linked in series between the two output terminals 16₁ and 16₂ of the switching legs 10₁ and 10₂.

Furthermore, an inductive element 22 is linked in series between the primary of the transformer and the output terminal 16₁ of the leg 10₁ to form a resonant element.

The secondary of the transformer 20 is in turn linked to a rectifier 24, the output terminals 26 of which form the output of the inverter 2.

The operation and control of such a circuit are known in the state of the art.

The control device 18 delivers only turn-off commands to the various switches 12. The switching from an off state to an on state is achieved spontaneously at zero voltage according to the quasi-resonant soft-switching principle, on receipt of a turn-on command sent by the control device 18.

In practice, the reactive energy stored in the resonance elements, or the capacitive elements 14 and the inductive element 22, to which can be added, if appropriate, the spurious capacitances of the switches 12 and the leakage inductance of the transformer 20, is used to obtain spontaneously, at the output terminals 16 of the legs 20, conditions for switching from the off state to the on state corresponding to a soft switching action.

In the context of quasi-resonance, the resonance phases provide for switching of a very short duration, on the scale of the switching frequency of the inverter, such as, for example, of the order of 1/10th of this period.

Such circuits present a large number of advantages over resonance inverters and/or inverters with controlled turn-on and turn-off.

However, the circuits are limited with regard to the operating range and in particular the level of output current amplitude variations.

In practice, below a limit current, the resonance capacitive elements 14 are discharged too slowly, so that the spontaneous turn-on conditions of the switching legs 10 are not satisfied. The inverter therefore does not function below this limit current.

This can raise major problems, particularly in the context of applications involving welding sets which require currents with an intensity varying throughout an operating range, extending, for example, from 10 to 500 amperes for a voltage of 50 volts.

There are inverters provided with auxiliary circuits for resolving this problem.

However, these auxiliary circuits are complex and use a large number of switches, so requiring the development of additional control circuits.

Furthermore, in the context of soft switching, such circuits are co-located with the secondary of the inverter's transformer, which limits their uses. In particular, the use of auxiliary circuits on the secondary is less easy in the context of welding sets.

The problem is therefore that there is currently no quasi-resonant soft-switching type inverter able to deliver an output current over an entire operating range, when it is incorporated in a welding set or welding current generator.

The solution of the invention is a welding set, characterized in that it comprises a quasi-resonant soft-switching type inverter comprising means of connection to an electrical energy power source including a DC voltage power supply terminal and a reference terminal, the inverter comprising at least one quasi-resonant type switching leg, each comprising an even number of switches connected in series between said power supply and reference terminals and including an output terminal taken between the two central switches of said leg, each switch being connected in parallel to a capacitive element and in series to an inductive element forming resonance elements, the inverter further comprising means of connection to a circuit controlling said switches and a transformer, the primary element of which is linked to said output terminals of the switching legs, and the secondary of which is linked to a rectifier delivering a DC inverter output voltage, and at least one intermediate power supply terminal taken at a potential of half the potential difference present between said DC voltage power supply and reference terminals, the output terminal of each switching leg being linked to an intermediate power supply terminal via an inductive element connected in series.

The use of the circuit according to the invention therefore makes it possible to produce a set with a quasi-resonant soft-switching type inverter, of a complexity no greater than that of the existing circuits, receiving the same type and the same number of control signals and capable of producing an output current with an intensity varying across the entire operating range of the inverter.

Depending on the case, the set according to the invention can include one or more of the following features:
the inverter comprises two switching legs arranged in parallel, the output terminal of each of said two legs each being linked to an intermediate power supply terminal via a separate inductive element, and said primary element of said transformer being linked in series between said two output terminals of said two switching legs;
the inverter comprises two intermediate power supply terminals each linked to an output terminal of a switching leg via a separate inductive element;
the inverter comprises a single switching leg, said primary element of said transformer being linked in series between the output of said switching leg and an intermediate power supply terminal, said primary element of said transformer being linked in series between said output terminal of the switching leg and said intermediate power supply terminal;
the inverter comprises at least one capacitive divider made up of an even number of capacitive elements arranged in series between said power supply and reference terminals, each capacitive divider comprising a terminal taken between the two central capacitive elements and forming an intermediate power supply terminal;
the inverter comprises at least one diode mounted in anti-parallel fashion between the power supply and reference terminals;
a head-to-tail configuration of two gated thyristors is arranged in series between each intermediate power supply terminal and each output terminal of a switching leg, said inverter also being linked to a device controlling said gated thyristors;
the inverter comprises an inductive element arranged in series with the primary of said transformer;
the transformer is a coupled planar transformer comprising two elements in series in the primary and two elements in parallel in the secondary;
it comprises a DC voltage source to which is linked an inverter, the output terminals of which form welding terminals, said welding set also including means of entering a welding set point and means of controlling said inverter.

The invention will be better understood on reading the description that follows, given solely by way of example and with reference to the appended drawings, in which:

FIG. 1, which has already been mentioned, represents an electrical circuit of a quasi-resonant soft-switching type inverter, of the state of the art;

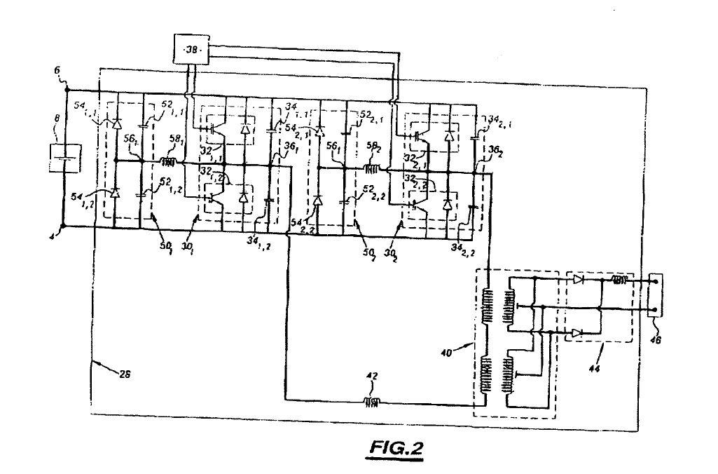

FIG. 2 represents an electrical diagram of a quasi-resonant soft-switching type inverter for the welding set according to the invention;

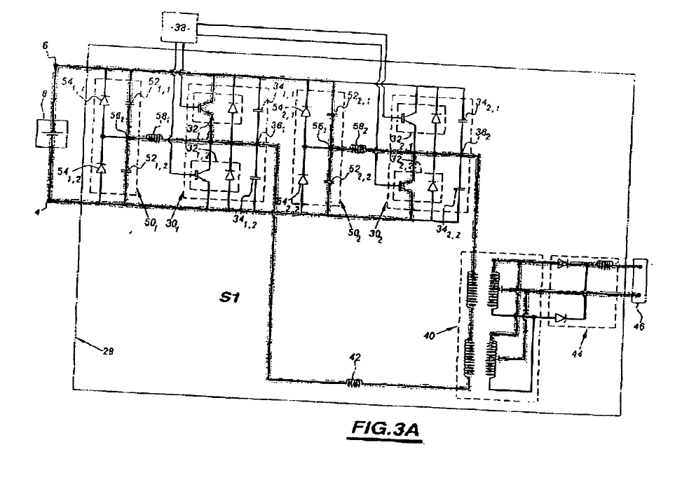

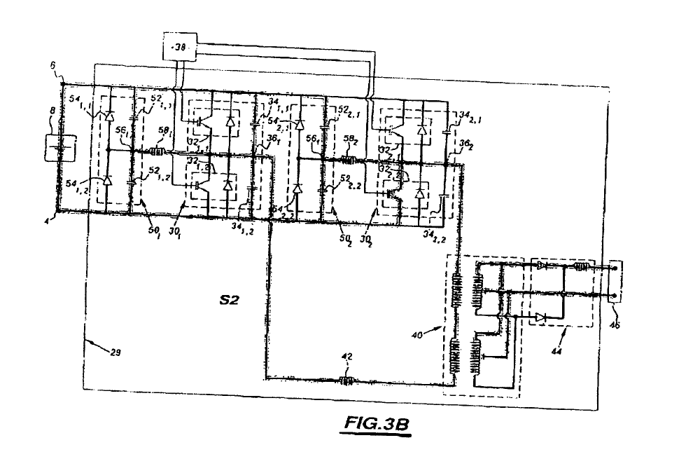

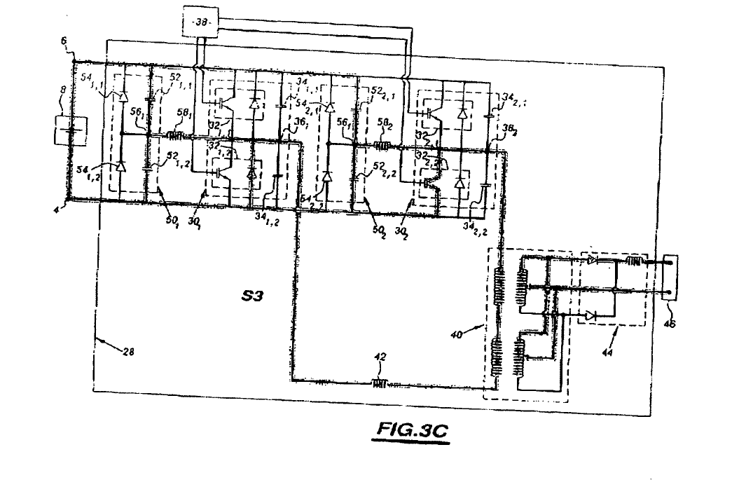

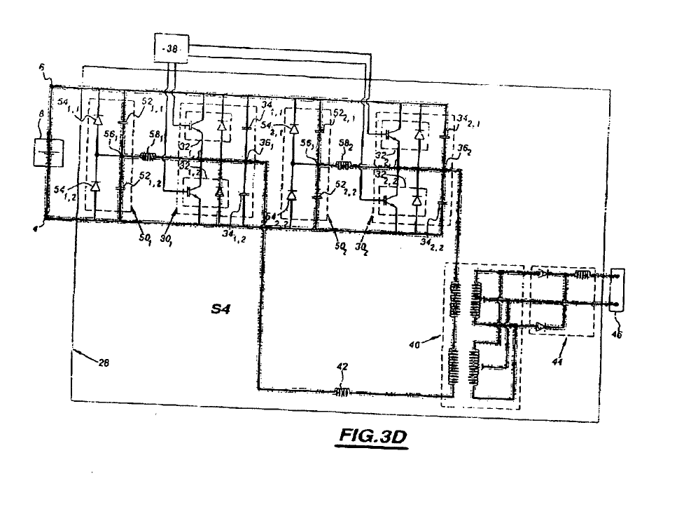

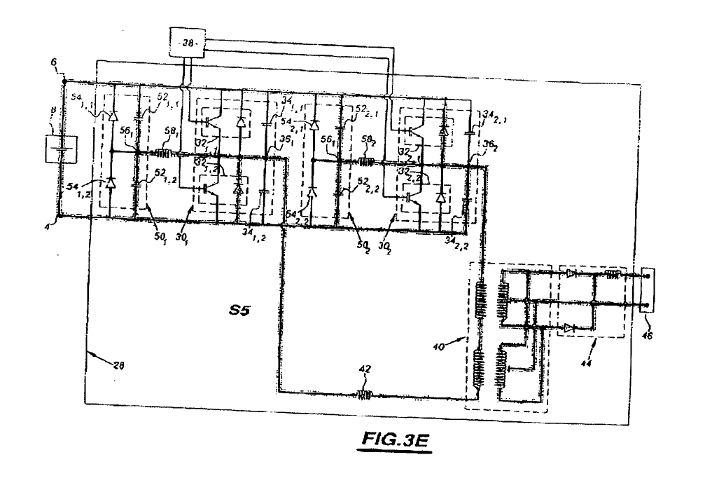

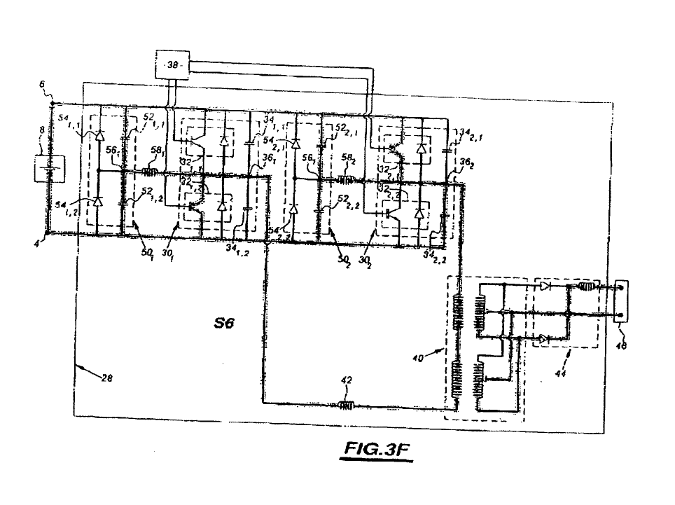

FIGS. 3A to 3F represent the circuit of FIG. 2 in different phases of operation;

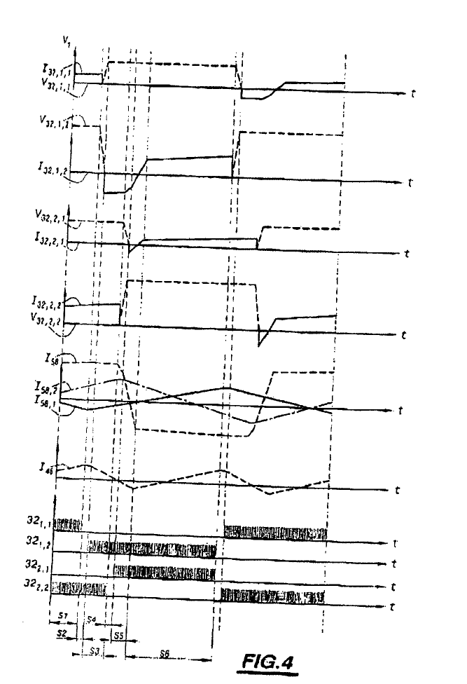

FIG. 4 represents a timing diagram of different signals during operation of the inverter described with reference to FIG. 2;

FIG. 5 represents an electrical circuit of a second embodiment of a quasi-resonant soft-switching type inverter for the set according to the invention;

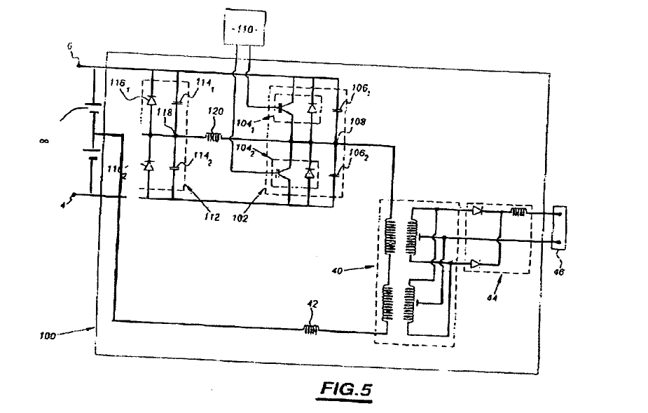

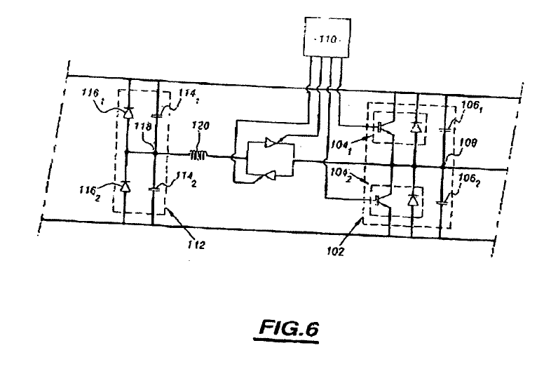

FIG. 6 represents a variant of a part of the circuit of FIG. 4; and

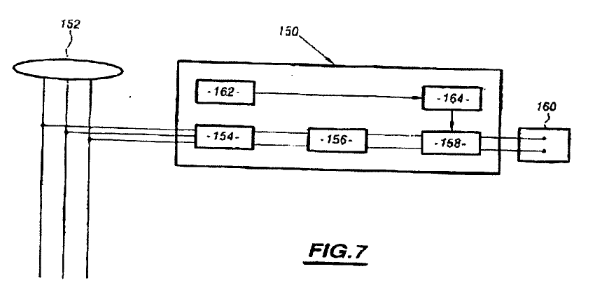

FIG. 7 represents a block diagram of a welding set with an inverter according to the invention.

In the text that follows, a set of components of the same type is denoted using a single general numeric reference while each component of this set is denoted using this numeric reference with an index. These indices are allocated according to a matrix-oriented notation, using two indices separated by a comma corresponding to column and row numbers in that order.

FIG. 2 shows the electrical circuit of a first embodiment of an inverter 28 for the welding set according to the invention.

This inverter 28 is connected between the reference and power supply terminals, respectively 4 and 6, of the DC voltage source 8 as defined previously with reference to FIG. 1. In the example, the voltage source 8 delivers a DC voltage of 600 volts.

The inverter 28 comprises two switching legs 30₁ and 30₂, arranged in parallel between the terminals 4 and 6 and each comprising two switches linked in series between the terminals 4 and 6. These switches are denoted in general by the numeric reference 32 and in particular by the references 32_{1,1}, 32_{1,2}, 32_{2,1} and 32_{2,2}.

The switches 32 are each also arranged in parallel with a capacitive element 34 assisting switching and forming a resonance element.

For example, the switches 32 are IGBT or MOSFET type switches such as, for example, the components denoted IXKN45N80C. The capacitive elements 34 are 2.2 nanofarad (nF) capacitors.

The switching leg 10₁ presents an output terminal 36₁ between the two switches 32_{1,1}, 32_{1,2} and the switching leg 10₂ presents an output terminal 36₂ between the switches 32_{2,1}, 32_{2,2}.

The switches 32 are each controlled by a control device 38 external to the inverter 28 and designed for a forced turn-off control of the switches 32 and their spontaneous turning on. Such a control is provided conventionally and will be described in greater detail later with reference to FIGS. 3A to 3F.

The inverter 28 also comprises a transformer 40, the primary of which is linked in series between the outputs 36₁ and 36₂ of the two switching legs 30.

In the embodiment described, the transformer 40 is a coupled planar transformer of twice 10.5 kW, the primary windings being in series and the secondary windings being in parallel.

Such a transformer is conventional in power electronics and will not be described further in detail.

The inverter 28 also comprises an inductive element 42 arranged in series between the output terminal 36₁ of the first switching leg 30₁ and the primary of the transformer 40.

In the example, the inductive element 42 is a 3 microhenry (μH) inductor.

The secondary of the transformer 40 is linked to a conventional type rectifier 44 using DSEP 2×101 diodes (400 volts of twice 100 A), and a 5 μH inductor.

The output terminals of the rectifier 44 directly form the output terminals of the inverter 28 and are denoted by the reference 46.

Moreover, the inverter 28 comprises two capacitive dividers 50₁ and 50₂ arranged in parallel between the power supply and reference terminals, respectively 6 and 4, of the DC voltage source 8.

These capacitive dividers are each made up of two identical capacitive elements 52 arranged in series between the terminals 4 and 6.

Advantageously, each of the capacitive elements 52 is mounted in anti-parallel fashion with a diode 54 used to limit the overall voltage present at the terminals of the inverter 28, to protect it from overvoltages.

For example, the capacitive elements 52 are 47 nanofarad (nF) capacitors and the diodes 54 are 30 ampere (A) BYT30P-1000 type diodes.

The capacitive dividers 50₁ and 50₂ each present an intermediate power supply terminal 56₁ and 56₂ which is at a potential half the potential difference present between the power supply terminal 6 and the reference terminal 4.

Finally, the inverter 28 comprises inductive elements 58₁ and 58₂ each arranged in series between an intermediate power supply terminal 56 and an output terminal 36 of a switching leg 30, such that the inductive element 58₁ is connected between the output terminal 36₁ and the intermediate power supply terminal 56₁ and the inductive element 58₂ is linked in series between the output terminal 36₂ and the intermediate power supply terminal 56₂.

As will become apparent later in FIGS. 3A to 3F, in such a circuit, the inductive elements 58₁ and 58₂ form resonance elements and help to create the soft switching conditions of the switches 32.

Moreover, the inductive element 42 is an optional element designed to reduce electromagnetic interference through its influence on the rise and fall rates of the voltage oscillations at primary level.

Where appropriate, this inductive element 42 is formed by the leakage inductance of the transformer 40.

The circuit of the invention as described can be used to obtain, via a controlled turn-off and spontaneous turn-on type 100 kHz operation control, an output at 50 volts of 0 to 500 amperes.

In practice, the use of inductive elements 58 forming resonance elements arranged between the intermediate power supply terminals 56 and the output terminals 36 of the switching legs 30 makes it possible to create the spontaneous turn-on conditions of the switches 32 with no lower current limit.

For a low load operation, the energy stored in the inductor 42 is no longer sufficient to fully discharge the capacitors 34 connected in parallel with the switches 32. The latter cannot therefore turn on spontaneously in soft switching mode. The additional energy is then supplied by the inductors 58.

The operation of the circuit will now be described with reference to FIG. 2.

Since the circuit of the invention is based on symmetrical operation, it will be described over a half-period with reference to FIGS. 3A to 3F in which the parts of the circuit in which a current circulates appear in bold, and FIG. 4, representing a timing diagram of the main signals of the circuit.

In the timing diagram of FIG. 4, the voltage and the current at the terminals of different components are represented, respectively referenced by the letters V and I with the number of the component as the index.

Furthermore, the state of each of the four switches 32 is also represented in the timing diagram of FIG. 4, an off state appearing in the form of a line and an on state in the form of a horizontal bar.

The operation of the circuit is broken down into six sequences denoted S1 to S6.

During the first sequence S1, it is assumed that the switches 32_{1,2} and 32_{2,1} are each in an off state, in other words see a zero current.

Conversely, the switches 32_{1,1}, 32_{1,2}, are in an on state, in other words are passing current and see a zero voltage between their power electrodes.

This phase S₁ corresponds to an active power transfer phase during which the primary winding of the transformer 40 sees a constant voltage.

The current of the switch 32_{1,1} is the sum of the current of the inductance present in the rectifier 44, returned to the primary of the transformer 40 and of the current circulating in the switching leg 30₁.

This sequence ends the off state of the switch 32_{1,1} following a command sent by the device 38.

The circuit then enters into the second operating sequence S2 during which the switches 32_{1,1}, 32_{1,2} and 32_{2,1} are switched to the off state whereas the switch 32_{2,2} is on.

The duration of the sequence S2 corresponds to the charging and discharging time of the resonance capacitors 34 associated with the switches.

In practice, since the switch 32_{1,1} is off, the current circulating in the leg 30₁ begins to charge the capacitor 34_{1,1} and, at the same time, discharges the capacitor 34_{1,2}.

Because of the capacitor 34_{1,1}, the voltage V_{32,1,1} at the terminals of the switch 32_{1,1} can only increase slowly, so enabling the switch to be turned off at zero voltage by zero voltage switching (ZVS).

During this time, the capacitor 34_{1,2} is discharged slowly during this phase and when fully discharged, the diode mounted in anti-parallel fashion with the switch 32_{1,2} is turned on spontaneously to provide current continuity.

The voltage at the terminals of the switch 32_{1,2} is then held at zero, creating spontaneous turn-on conditions in ZVS mode.

During the sequence S3, the switches 32_{1,1}, 32_{2,1} are both turned off whereas the switches 32_{1,2} and 32_{2,2} are on, such that the primary winding of the transformer 40 sees a zero voltage after cancelling the voltage at the terminals of the capacitor 34_{1,2}.

The two diodes of the rectifier 44 are then on in a “freewheeling mode” and the current passing through the primary of the transformer 40 is held constant.

The duration of the sequence S3 is determined by the phase difference duration needed for power adjustment.

During the sequence S3, the inductor 58, sees a positive and constant voltage and a current growing linearly from its minimum value.

The circuit then enters into the sequence S4 at the start of which the switch 32_{2,2} is turned off in ZVS mode, such that the switches 32_{1,1}, 32_{2,1} and 32_{2,2} are turned off, whereas only switch 32_{1,2} is on.

The duration of this operating sequence corresponds to the charging and discharging time of the resonance capacitors 34 of the switching leg 30₂.

Thus, when the switch 32_{2,2} is off, the current circulating from the inductor 58₂ reaches its positive peak value and, similarly to sequence 1, begins to charge the capacitor 34_{2,2} and discharge the capacitor 34_{2,1}.

The voltage at the terminals of the capacitor 34_{2,2} begins to increase from zero while that at the terminals of the capacitor 34_{2,1} begins to decrease.

Immediately the voltage at the terminals of the capacitor 34_{2,1} begins to decrease, the transformer 40 sees a negative voltage set up because the switch 32_{1,2} is already on.

Because of the capacitor 34_{2,2}, the voltage V_{32,2,2} at the terminals of the switch 32_{2,2} can only increase slowly, ensuring turning off in ZVS mode.

The gradual discharging of the capacitor 34_{2,1} returns the voltage at the terminals of the switch 32_{2,1} to zero during this interval, so enabling it to be turned on spontaneously in ZVS mode.

During this phase, the current circulating in the switching leg 30₂ is equal to the current circulating in the inductor 58₂ minus the charging current returned to the primary of the transformer 40. This therefore reduces the current stresses applied to the switch 32_{2,2} in the off state as well the current needed to discharge the capacitor 34_{2,1}.

To achieve the spontaneous turning-on of the switch 32_{2,1}, the capacitor 34_{2,1} must be completely discharged during the time of this sequence S4 to enable spontaneous switching on.

The circuit then enters into the fifth operating phase, denoted S5, at the start of which the switch 32_{2,1} is turned on spontaneously in ZVS mode, such that the switches 32_{1,1} and 32_{2,2} are set to off, whereas the switches 32_{1,2} and 32_{2,1} are on.

Since the switch 32_{2,1} is on, the inductor 58₂ sees a constant negative voltage, such that the current begins to decrease linearly at its terminals.

This sequence S5 ends when the first diode of the rectifier 44 is turned off.

The circuit then starts a sixth operating sequence S6, during which the switches 32_{1,2}, 32_{2,1} are on, whereas the others are off and the first diode of the rectifier 44 is off whereas the second is on. This sequence is symmetrical to the sequence S1 and marks the start of another operating half-cycle symmetrical to the preceding operation sequences.

Together, the six operation sequences thus form a complete operating cycle of this circuit.

With reference to FIG. 5, a second embodiment of an inverter for the welding set according to the invention will now be described.

In this embodiment, the inverter 100 comprises a single switching leg 102 arranged between the reference and power supply terminals, respectively 4 and 6, of the DC voltage source 8.

This leg 102 comprises, as previously, two switches 104₁ and 104₂ arranged in series between the terminals 4 and 6, switching-assisting capacitive elements 106₁ and 106₂ being arranged in parallel at the terminals of each of these switches 104.

The switching leg 102 has an output terminal 108 taken between the switches 104₁ and 104₂.

The switches 104₁ and 104₂ are both linked to a control device 110, external to the inverter 100 and designed for a forced turn-off command and spontaneous turn-on command, produced in the conventional manner.

The inverter 100 also comprises a capacitive divider 112 formed, as previously, by two identical capacitive elements 114₁ and 114₂ arranged in series between the terminals 6 and 4 and two diodes 116₁ and 116₂ arranged in anti-parallel fashion on each of these capacitive elements.

The capacitive divider presents a centre power supply terminal 118 taken between the capacitive elements 114₁ and 114₂, the potential of which corresponds to half the potential difference between the terminals 4 and 6.

An inductive resonance element 120 is connected in series between the output terminal 108 of the switching leg 102 and the centre power supply terminal 118 of the capacitive divider 110.

Finally, the inverter 100 comprises, as previously, the coupled transformer 40 linked in series with the inductive element 42.

In this embodiment, the primary of the transformer 40 is linked in series between the output 108 of the switching leg 102 and the centre power supply terminal 118.

The secondary of the transformer 40 is linked to the rectifier 44, the output terminals of which form the output terminals of the inverter 100.

The operation of this circuit is similar to that of the circuit described with reference to FIG. 2, and it will not be described further in detail, given that performance characteristics of the same order can be obtained.

This configuration presents the advantage of using only two switches 104 instead of four, but with variable frequency operation.

FIG. 6 shows a variant of a part of the circuit described with reference to FIG. 5.

In this figure can be recognized the capacitive divider 112, the intermediate power supply terminal 118 of which is linked to the output terminal 108 of the switching leg 102 through the inductive element 120.

In this embodiment, a head-to-tail configuration of two gated thyristors 130 is linked in series between the inductive element 120 and the output terminal 108.

These thyristors 130 are directly controlled by the control device 110 or by another device of the same type and receive specific control signals produced in the conventional manner.

In the circuit described with reference to FIG. 4, the control device 110 supplies a constant current to control the switches 104. By adding the thyristors 130, these controls are no longer necessary other than in the switching phases, so that the total current circulating in the circuit can be limited.

The use of such a circuit means that the triangular type control signals can be replaced by simple pulses at the switching instants.

Naturally, this configuration can be used in the circuit described with reference to FIG. 2 by inserting, between each intermediate power supply terminal and each output terminal of a switching leg, a set of two gated thyristors in head-to-tail series configuration.

With reference to FIG. 7, there now follows a description of an inverter-based welding set according to the invention.

The welding set 150 is linked to an electrical energy transfer network such as a three-phase network 152. The energy received from the three-phase network 152 is received first in insulation means such as, for example, a transformer 154 providing electrical insulation between the welding set 150 and the three-phase network 152.

The transformer 154 delivers a power AC signal to a rectifier 156 forming a DC voltage source to which is connected an inverter 158 corresponding, for example, to the inverter 28 as described with reference to FIG. 2 or even the inverter 100 as described with reference to FIG. 4. The transformer 154, the rectifier 156 and the inverter 158 combined in this way form a power converter between an AC voltage source and a DC voltage source, and vice versa.

The output terminals of the inverter 158 are connected to welding terminals 160 forming the welding terminals for arc welding purposes.

Moreover, the welding set 150 also comprises means 162 of entering a set point for welding. This set point is transmitted to a control device 164 corresponding to the control device 38 described with reference to FIG. 2 or to the control device 110 described with reference to FIG. 4. The control device 164 finally delivers control signals to the inverter 158 to form an output signal at the terminals 160, corresponding to the set point.

Naturally, different types of controls and set points can be envisaged according to the required applications. In particular, the inverter according to the invention can be used in a variable duty cycle or phase shift control welding set.

Moreover, the components used in the inverter can be produced in different ways. In particular, the switches can conventionally be made of one or more identical transistors or MOSFETs positioned in series, such that the switches overall are unidirectional in voltage mode and bidirectional in current mode and are made up of electronic components that are unidirectional in voltage mode and unidirectional in current mode.

The capacitive elements can be made up of a number of capacitors connected in parallel, and the inductive elements of a number of inductors connected in series. The number and nature of each of the electronic components used varies according to the maximum voltage and the maximum current applicable between the terminals of each switch.

Moreover, different electronic components can be aggregated, with one and the same component handling a number of functions. In particular, the switching-assisting capacitive elements can be combined with the capacitive elements of the capacitive dividers. The dimensioning of such components must, however, take account of the stresses imposed by the different functions.

In the embodiments described, the intermediate power supply terminals are obtained using capacitive dividers produced in the conventional manner.

However, these terminals can be directly available at the DC voltage source without needing any capacitive divider, the intermediate power supply terminals then being simply formed by connection terminals. Such an embodiment is particularly suited to the case where the DC voltage source is made up of a plurality of batteries connected in series, on which a number of intermediate voltage terminals are accessible.

Finally, although the invention has been described in the context of a welding set, it is also possible to use the inverter according to the invention in other application domains, such as, for example, rechargeable battery charging or standard stabilized power supplies.

The set according to the invention therefore presents a large number of advantages over the sets with resonance or controlled turn-off inverters, and in particular:
the stresses on the components are minimal, the resonance energy involved being very low compared to the total energy of the system;
the switching-assisting circuits are simple and need not even exist;
the overall cost of the circuit is considerably reduced; and
the output current operating range is extended.

1-10. (canceled)

11. An apparatus which may be used for welding, said apparatus comprising a quasi-resonant, soft-switching type inverter, wherein said inverter comprises:
a) a connection means for connecting to an electrical energy power source, said means comprising:
1) a DC voltage power supply terminal; and
2) a reference terminal;
b) at least one quasi-resonant type switching leg, wherein said leg comprises:
1) an even number of switches connected in series between said power supply and said reference terminal, wherein:
a) each said switch is connected in parallel to a capacitive element; and
b) each said switch is connected in series to an inductive element forming resonance elements; and
2) an output terminal, wherein said output terminal is located between the two central switches of said leg;
c) a connection means for connecting to a control circuit for said switches;
d) a transformer, wherein said transformer comprises:
1) a primary element connected to said output terminal; and
2) a secondary element connected to a rectifier, wherein said rectifier delivers a DC inverter output voltage; and
e) at least one intermediate power supply terminal wherein:
1) said intermediate power supply terminal has a potential of approximately half the potential difference between said DC inverter output voltage and said reference terminal; and
2) said output terminal is linked to said intermediate supply terminal by an inductive element arranged in series.

12. The apparatus of claim 11, wherein:
a) said inverter further comprises two switching legs arranged in parallel;
b) the output terminal of each said two switching legs is linked to said intermediate power supply terminal by a separate inductive element; and
c) said primary element of said transformer is linked in series between said two output terminals of said two switching legs.

13. The apparatus of claim 12, wherein:
a) said inverter comprises two intermediate power supply terminals; and
b) each said intermediate power supply terminal is connected to said output terminal of said switching leg by a separate inductive element.

14. The apparatus of claim 11, wherein:
a) said inverter comprises a single switching leg;
b) said primary element of said transformer is arranged in series between the output of said switching leg and an intermediate power supply terminal.

15. The apparatus of claim 14, wherein said primary element of said transformer is arranged in series between said output terminal of said switching leg and said intermediate power supply terminal.

16. The apparatus of claim 11, wherein:
a) said inverter comprises at least one capacitive divider;
b) said capacitive divider comprises an even number of capacitive elements arranged in series between said power supply and said reference terminals; and
c) each said capacitive divider further comprises a intermediate power supply terminal, wherein said intermediate power supply terminal is located between the two central said capacitive elements.

17. The apparatus of claim 11, wherein said inverter comprises at least one diode mounted in an anti-parallel fashion between said power supply terminal and said reference terminal.

18. The apparatus of claim 11, further comprising a head-to-tail configuration of two gated thyristors, wherein:
a) said thyristors are arranged in series with said inductive element between:
1) each said intermediate power supply terminal; and
2) each said output terminal of said switching leg; and
b) said inverter is also linked to a first controlling means for controlling said thyristors.

19. The apparatus of claim 11, wherein said inverter further comprises an inductive element arranged in series with said primary of said transformer.

20. The apparatus of claim 11, wherein said transformer is a coupled planar transformer comprising:
a) two elements arranged in series in said primary; and
b) two elements arranged in parallel in said secondary.

21. The apparatus of claim 11, further comprising:
a) a secondary DC voltage source, wherein:
1) said secondary DC voltage source is linked to said inverter; and
2) the output terminals of said secondary DC voltage source form welding terminals;
b) an entry means for entering a welding set point; and
c) a second controlling means for controlling said inverter.
